(19) United States
(12) Patent Application Publication
(10) Pub. No.: US 2013/0001174 A1
(43) Pub. Date: Jan. 3, 2013

(54) STERILIZATION OF MEMBRANE FILTERS

(75) Inventors: Jörg Zacharias, Koefering (DE); Dirk Scheu, Amerdingen (DE)

(73) Assignee: KRONES AG, Neutraubling (DE)

(21) Appl. No.: 13/536,608

(22) Filed: Jun. 28, 2012

(30) Foreign Application Priority Data
Jun. 29, 2011 (DE) 10 2011 078 345.8

(51) Int. Cl. B01D 35/16; B01D 35/18

(52) U.S. Cl. 210/774; 210/184

(57) ABSTRACT

The disclosure relates to a filter module comprising a filter housing sealable in a pressure-tight manner, and a heating device for heating a fluid in the filter housing. The disclosure further relates to a method for sterilizing a filter module comprising the steps of: sealing a filter housing in a pressure-tight manner, heating fluid in the filter housing to a sterilizing temperature, preferably in the range of 100° C. to 150° C., most preferably in the range of 121° C. to 140° C., and maintaining the sterilizing temperature of the fluid in a predetermined temperature range for a predetermined period, wherein the predetermined temperature range is preferably within 100° C. to 150° C., most preferably within 121° C. to 140° C., and wherein the predetermined period is preferably in the range of 1 minute to 60 minutes, most preferably in the range of 5 minutes to 20 minutes.

### CROSS-REFERENCE TO RELATED APPLICATIONS

This application claims foreign priority benefits under 35 U.S.C. §119(a)-(d) to German patent application number DE 10 2011 078 345.8, filed Jun. 29, 2011, which is incorporated by reference in its entirety.

### TECHNICAL FIELD

The present disclosure relates to a sterilizable filter module/membrane module. The disclosure further relates to a method for sterilizing a filter module/membrane module.

### BACKGROUND

So-called filter modules/membrane modules are used for water conditioning, where specific and/or undesired materials are filtered out of an inflowing medium (medium to be filtered or unfiltered material, respectively, e.g., raw water, milk, or other fluids). The filtered medium flows out of the filter module in the form of a filtrate (permeate), while a concentrate (retentate) remains. Membrane filter modules are frequently used for water conditioning, for example ultrafiltration modules, in which above all germs (bacteria, yeasts) have to be removed from the medium to be filtered or retained, respectively.

Usually, a difference between microfiltration and ultrafiltration is made on the basis of the size of the separated particles. If particles with a size of 0.5 to 0.1 μm are separated one talks about microfiltration. If the particles have a size of 0.1 to 0.01 μm the filtration is called ultrafiltration. As a rule, plastic membranes (hollow fibers, flat membrane, wound membrane) are employed for this purpose, the pore size of which is in a range of about 1 μm to 0.001 μm. Special ultrafiltration membranes usually have a size of 0.2 to 0.02 μm. In some fields also ceramic membranes are used. In addition to that, also filters based on the reverse osmosis principle and candle filters are in use. Additionally known is the gravel aggregate bed filter principle.

If plastic membranes are used, the cleaning temperature and a sanitation temperature or sterilization temperature, respectively, are of great significance. The cleaning temperatures and sanitation temperatures or sterilization temperatures used so far normally have a maximum temperature of 60° C. to 85° C. only. Due to a limited material resistance, especially also of the potting compounds (potting methods) and of the membrane itself, these temperatures must not be exceeded.

For cleaning purposes it is provided in the prior art to supply hot water or vapor instead of the medium to be filtered. However, this leads to great temperature gradients inside the filter module and on the membranes, and represents another problem for the cooling.

If the ultrafiltration or microfiltration is accomplished with hollow fiber membranes where, for example, unfiltered material is supplied to the inside of the hollow fiber membranes and permeate is sucked off on the outside thereof (in-out filtration), the weak point in terms of hygiene exists above all on the side of the filtrate. In this case, the retentate side is not so important because this is where the medium contaminated in the process flows anyhow. On the other hand, if the direction of filtration is reversed, with permeate being sucked off from the inside of the hollow fiber membranes (out-in filtration), at least a part of the retentate can settle in the filter module and results in unhygienic residues. Moreover, specifically connection portions and sealing points of the membrane potting as well as connections to be found on the housing are critical areas in terms of hygiene e.g., non-hygienic seals with O-rings.

The greatest problem in connection with membrane modules are all spots which are not accessible for cleaning in a conventional manner, and which are accessible, if at all, by cleaning agents and disinfectants only diffusively. In other words, no fluidic material exchange takes place at these dead spots which could carry off dirt or germs. In particular, this also refers to the pools at the junction region between the membrane and the membrane potting, where excessive deposits may be built up, which can only be removed insufficiently due to the low flow speed there. As the exchange of media is here mainly diffusive, it is usually attempted to clean the module with a hot water flow there through and kill germs present in the module by the heat.

Therefore, if plastic membranes are used, the cleaning temperature is of great importance. Previous cleaning temperatures and sanitation temperatures or “sterilization” temperatures, respectively, of up to a maximum of only 60° C. to 85° C. are standard in this case. The designation “sterilization” at these temperatures is not yet justified, however. One usually talks about sterilization as of temperatures of 121° C. (e.g., for 20 minutes or more), ideally up to 140° C. Thus, low temperature applications are usually called hot water sanitations.

Moreover, the temperature gradient at which the membrane is heated up to this sanitation temperature and is cooled down again afterwards is extremely critical. Due to different material expansion coefficients this temperature gradient must, as a rule, not exceed 1-2° C./min. Otherwise, a fast material fatigue and material strain or material overstress, respectively, may be the consequence, finally resulting in the breakage of the membranes or in the detachment of the jacket from the potting or of the membrane relative to the potting. The most frequently observed damage is the breakage of the membrane directly at the junction to the potting, however. Thus, these membrane modules are damaged to such an extent that they have to be exchanged.

Hence, the problem is that higher temperatures (>85° C.) and simultaneous pressure and differential pressure variations are usually out of the question because either the membrane or the housing, the sealing, or the potting are not suited for these pressure/temperature gradients. Higher temperatures result in damages to the material. Moreover, if the heating and cooling takes place too fast, the material fatigues, which likewise results in premature material damages. Above all, the potting of the membrane relative to the housing is problematical, i.e., the connection of the membrane to the epoxy and from the epoxy, for example, to the PES wall or PVC wall or a metallic outer wall. In addition, also the choice of membrane is significant. In many systems, PES (polyether sulfone) is used as material for the plastic membrane. In the beverage industry, frequently, also stainless steel jackets are integrated. Since, as a rule, a direct potting into these stainless steel sleeves is not possible owing to the material, membrane module cartridges are inserted into outer stainless steel jackets.

Summarizing, membrane modules are critical in terms of hygiene owing to lacking cleaning, disinfecting and sanitation capabilities and sterilization capabilities. One point of criticism is above all the growth of germs inside the module. Especially pools and dead spots inside the modules are critical, which are not subjected to an intensive material exchange induced by fluid flow. Moreover, many membrane modules are not built in in compliance with aseptic criteria. Connecting flanges, too, are not constructed in compliance with the common directives for hygienic design. Therefore, it is desirable that these modules are sterilized (at temperatures of 121° C. or more), which had so far technically not been repeatable, however, due to the materials and the construction, without causing damage to the module or membrane.

Given these disadvantages of the prior art it is, therefore, an object of the present disclosure to avoid these disadvantages and allow a sterilization of a filter module.

### SUMMARY

The aforementioned object is achieved by a filter module, comprising a filter housing sealable in a pressure-tight manner and a heating device for heating a fluid in the filter housing. This construction allows the sterilization of the membrane module according to the disclosure, namely to a much higher temperature level than the one used so far. By sealing the filter housing in a pressure-tight manner, and by heating the fluid contained inside the filter housing by means of the heating device, the fluid (usually water) can be heated up gradually and largely uniformly. Thus, strains within the module can be avoided. Also, the stresses caused by the flow conditions during the usual filtration operation are avoided. In addition, this heating may be accomplished at a temperature of more than 100° C. as the filter housing is sealed in a pressure-tight manner, so that the water vapor does not escape.

One further development of the filter module according to the disclosure is that one or more closable inlets for supplying a medium to be filtered and one or more closable outlets for discharging the filtered medium may be provided on the filter housing. Thus, it is possible to easily seal the filter housing in a pressure-tight manner, namely by both closing the inlet and the outlet. This may be realized, for example, by corresponding valves.

Another further development of the filter module is that the heating device may comprise a jacket for the filter housing, which is designed, at least in part, double-walled, with a hollow space there between, and wherein the hollow space can be filled with and/or flown through by a heating medium. A jacket frequently provided around the membrane element anyhow may, in this case, be designed to form a double jacket. This double jacket may be filled with, and also flown through by a heating medium or cooling medium. The double jacket may be a double jacket formed, for example, of concentric sleeves. The hollow space in the double jacket is filled with and/or flown through by hot water or saturated vapor. Pressurized hot water allows temperatures of far higher than 121° C. The temperature of 140° C. normally used is possible as well. The system pressure has to be kept above the vapor pressure of the boiling curve.

According to another further development the hollow space further comprises an intake and a drain for the heating medium, specifically for hot water and/or hot vapor as heating medium. The intake allows a fast supply there through of the heating medium. After the sterilization is terminated, a cooling medium can be passed there through.

According to another embodiment the heating device comprises at least one electric heating element arranged in the filter housing, or the heating device comprises at least one electric heating element arranged on the filter housing, wherein this heating element is arranged on an inner side of the filter housing pointing to the fluid, and/or the heating element is integrated in a wall of the filter housing, specifically in a bottom area and/or a lid area of the filter housing, and/or the heating element can be arranged, at least in part, in the hollow space. In this way, too, can a heating of the filter module be provided so as to heat up and sterilize the fluid in the filter module.

Specifically, the electric heating element can comprise a heating cable, preferably in the form of a heating coil. This represents an inexpensive realization of the heating element.

The electric heating element may also be realized in the form of a Peltier element (electrothermal transformer), thereby achieving the additional advantage that it is also possible to cool the filter housing.

In addition to, or as an alternative to the double-walled design of the filter housing and the electric heating element, the heating device can also comprise a firing of the filter housing, specifically of a bottom area of the filter housing. Thus, too, it is easily possible to heat the filter housing, which is sealed in a pressure-tight manner, to sterilization temperature.

One or more membranes, specifically flat membranes or hollow fiber membranes, may be arranged in the filter housing, or a wound membrane or a gravel aggregate bed may be arranged in the filter housing. This allows the sterilization according to the disclosure with commonly used filter media.

The above-mentioned problem or defined object is further solved by a method for sterilizing a filter module according to the disclosure or one of its further developments, the method comprising the steps of: sealing the filter housing in a pressure-tight manner, heating the fluid in the filter housing to a sterilizing temperature, preferably in the range of 100° C. to 150° C., most preferably in the range of 121° C. to 140° C., and maintaining the sterilizing temperature of the fluid in a predetermined temperature range for a predetermined period, wherein the predetermined temperature range is preferably within 100° C. to 150° C., most preferably within 121° C. to 140° C., and wherein the predetermined period is preferably in the range of 1 minute to 60 minutes, most preferably in the range of 5 minutes to 20 minutes.

The advantages of the method according to the disclosure and the further developments thereof as described below correspond to those described above in connection with the filter module according to the disclosure. Therefore, a repetition is waived.

The method according to the disclosure can be developed further by accomplishing the heating of the fluid by hot water and/or hot vapor flowing through the hollow space.

Another further development of the method according to the disclosure is that after the heating of the fluid to the sterilizing temperature and after maintaining the sterilizing temperature of the fluid, the following additional step is carried out: cooling the fluid, specifically by water flowing through the hollow space, which has a lower temperature than the hot water and/or the hot vapor, specifically by supplying water which has an ambient temperature, preferably 50° C. to 40° C., most preferably 10° C. to 20° C., into the intake.

Other features and exemplary embodiments as well as advantages of the present disclosure will be explained in more detail below by means of the drawings. It will be appreciated that the embodiments do not limit the scope of the present disclosure. It will also be appreciated that some or all of the features described below may also be combined with each other in a different way.

### DESCRIPTION OF THE DRAWINGS

FIG. 1 shows a first embodiment of a filter module according to the disclosure;

FIG. 2a shows a second embodiment of a filter module according to the disclosure;

FIG. 2b shows a modification of the second embodiment;

FIG. 3a shows a third embodiment of a filter module according to the disclosure;

FIG. 3b shows a modification of the third embodiment;

FIG. 4 shows a fourth embodiment of a filter module according to the disclosure;

FIG. 5 shows a fifth embodiment of a filter module according to the disclosure; and

FIG. 6 shows a sixth embodiment of a filter module according to the disclosure.

### DETAILED DESCRIPTION

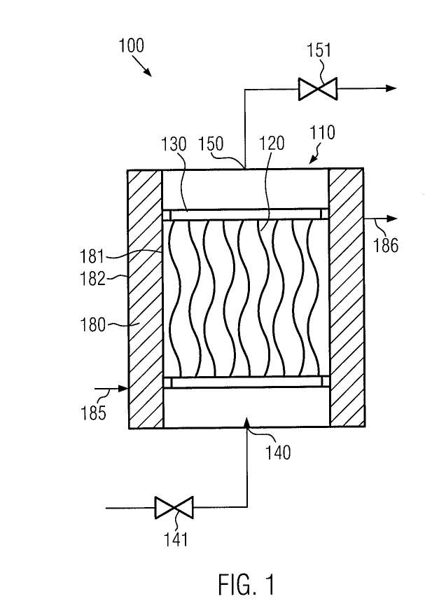

FIG. 1 shows a first embodiment of a filter module 100 according to the disclosure. The filter module 100 comprises a filter housing 110 which is sealable in a pressure-tight manner. Unfiltered material is fed through the inlet 140, with a supply conduit being closable by a valve 141. Permeate is discharged through the outlet 150, and the associated conduit can be closed by a valve 151. If a cross flow module is used (cross flow filtration), which is flown through by unfiltered material, that is, unfiltered material flows into the filter module and out again, at least one additional closable outlet is provided (not shown in FIG. 1). If valves 141, 151 are closed, the filter housing is sealed in a pressure-tight manner so as to allow a heating of the fluid contained therein above the boiling temperature at atmospheric pressure.

The filter module 100 further comprises a heating device including, in this first embodiment, a filter housing jacket, which is double-walled by means of walls 181 and 182 so as to define a hollow space 180, through which a hot medium may be passed, e.g., hot water or hot vapor. The heating medium is supplied through an intake 185 and discharged through drain 186. If a sterilization of the filter module is desired, valves 141 and 151 are closed so that it is possible to build up pressure in the filter housing 110 and heat up the fluid contained therein to a high temperature. The heating is accomplished by supplying a heating medium into the hollow space 180, which is flown through by the heating medium. At the same time, also the fluid in the filter housing is heated. Germs settled, for example, on the hollow fiber membranes 120 or the encapsulating material/potting material 130 can thus be killed. As a rule, a heating to 121° C. to 140° C. is provided in this case, namely over a period of 20 minutes or more. After this sterilization, a cooler medium can be introduced through the inlet 185, resulting in a graduate cooling of the fluid in the filter housing 110. The heating and cooling of the fluid in the filter housing is, therefore, carried out slowly, so that no sudden strains can occur.

For vertical microfiltration and ultrafiltration membrane modules a construction with a double jacket module is suitable because vertical assemblies allow a more uniform and more symmetrical heating of all components of the construction across the height, without asymmetrical transverse distortions. The horizontal assembly is advantageous in particular for reverse osmosis modules, however, as these are normally arranged horizontally due to their constructive conditions. As opposed to the above-described membranes, wound modules are built in so that thermally induced transverse distortions do not occur in dangerous magnitudes. Moreover, a spring for the compensation of the heat expansion may be provided in this system so as to avoid material strains. The double jacket may also be divided into several sections.

In the figures described below the reference numbers of corresponding features differ from those of FIG. 1 merely by the hundreds digit. With regard to the description of the same features reference is made to the description of FIG. 1.

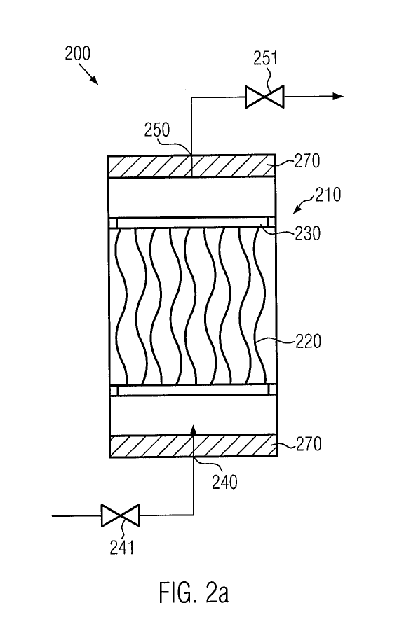

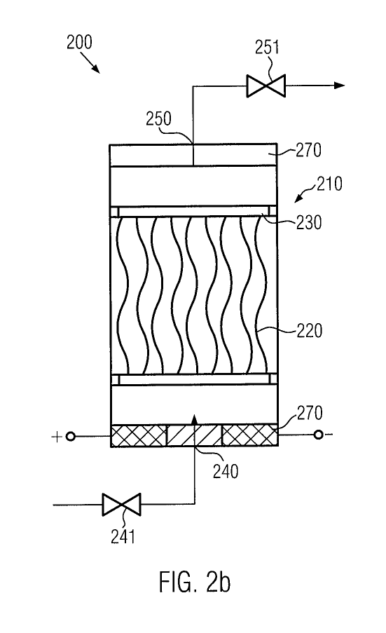

FIG. 2a shows a second embodiment of the filter module 200 according to the disclosure. The heating device in this embodiment comprises a massive design of the bottom and lid areas 270 in which heating coils corresponding to an electric hot plate are installed. Thus, the fluid in the filter housing 210 can be heated up gradually. In this case, the cooling can only be realized by a heat dissipation to the environment, however.

FIG. 2b shows a modification of the second embodiment. The plate(s) of the bottom and/or lid area 270 may, in this case, be constructed as Peltier element(s). In the example shown, the lower plate (bottom plate) is formed as a Peltier element with electrical terminals (+/−). This additionally allows a cooling based on the reversal of the current direction, which may be carried out after the sterilization is terminated.

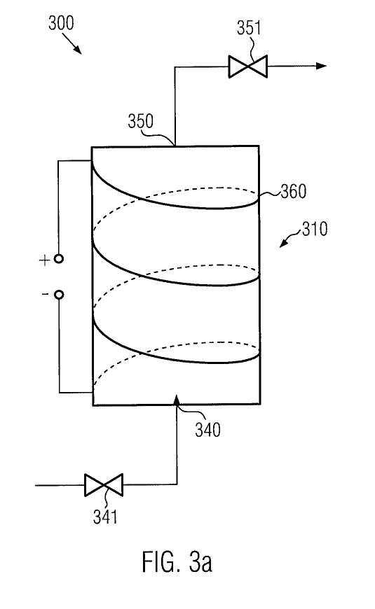

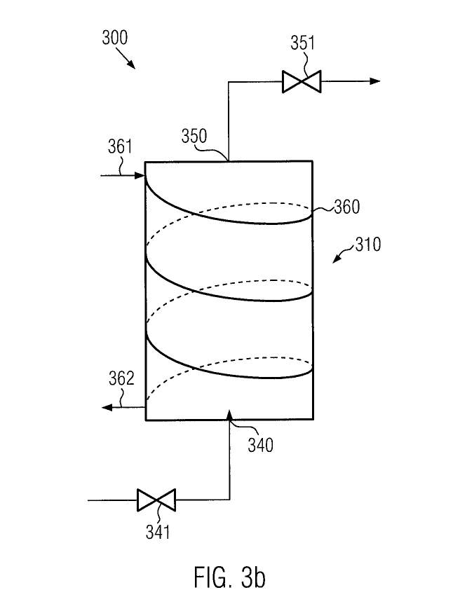

FIG. 3a shows a third embodiment 300 of the filter module according to the disclosure. In this embodiment, the heating device is comprised of a heating coil 360, which is wound around the housing 310 of the filter module 300 and can be heated by conducting electric current through the same. The aforementioned heating coils may also be interwoven as concentric rings or in parallel additional sections.

FIG. 3b shows a modification of the third embodiment. In this case, heating coils 360 may also be designed functionally, like in the first embodiment according to FIG. 1, e.g., in the form of a conduit 360, so that a heating medium can flow there through. They may also be formed in sections. An inlet 361 and an outlet 362 for the heating medium are provided. In addition, or alternatively, a so-called “dimple plate” design or a “tample plate” design may be chosen.

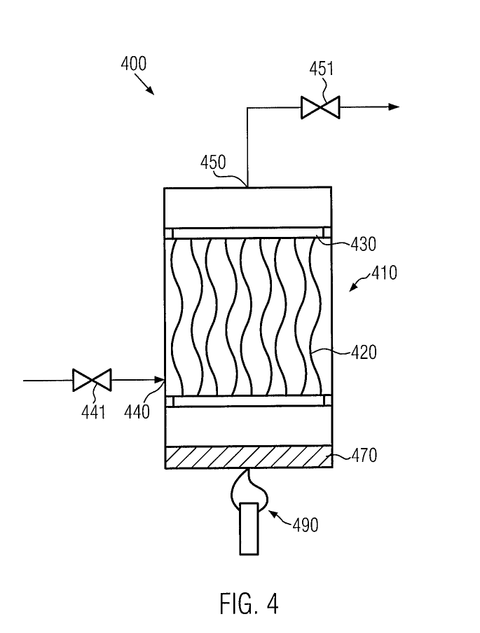

FIG. 4 shows a fourth embodiment 400 of the filter module according to the disclosure, in which the heating device is formed of a firing system 490, e.g., a gas burner. In this case, the bottom area of housing 410 is directly heated by a flame, so that the heated bottom area then emits the heat to the fluid which is enclosed in a pressure-tight manner.

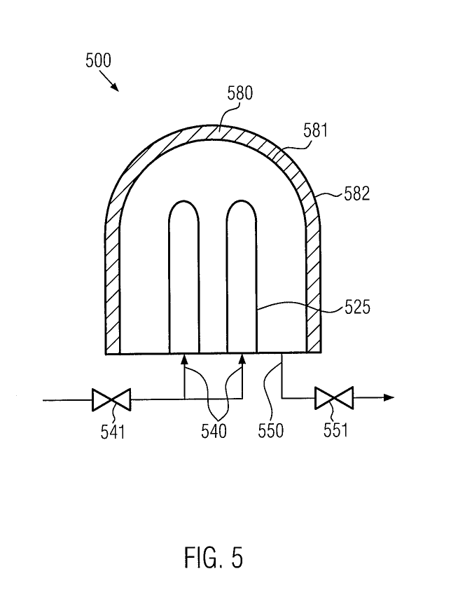

FIG. 5 shows a fifth embodiment 500 of the filter module according to the disclosure. In this embodiment the filter module is a candle filter with wound membranes 525. Unfiltered material is introduced into the wound membranes through the inlets 540 and sucked off in the form of permeate through the outlet 550. In correspondence with the first embodiment 100, the housing is double-walled, namely with an inner wall 581 and an outer wall 582, so that a hollow space 580 is defined which, again, can be filled with or flown through by a heating medium. The housing of the filter module 500 may also be sealed in a pressure-tight manner by closing the valves 541 and 551, and the fluid contained therein can be heated to a high temperature, namely above the boiling temperature at atmospheric pressure.

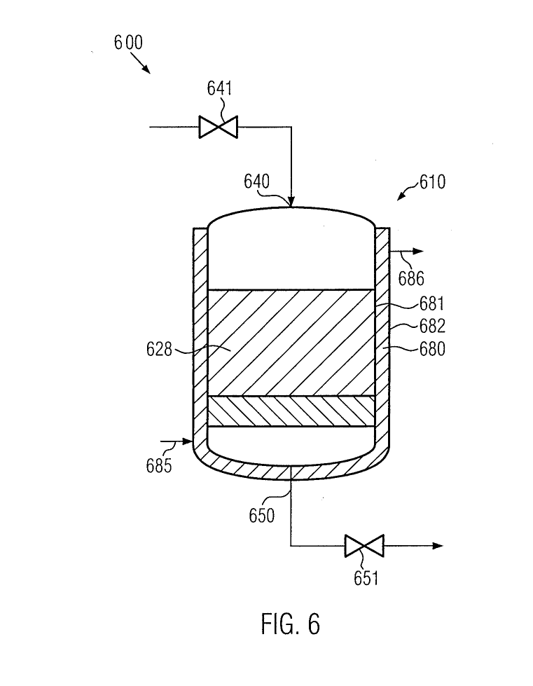

FIG. 6 shows a sixth embodiment 600 of the filter module according to the disclosure. In this embodiment the filter module is a gravel aggregate bed filter. For example, unfiltered water is filled in through the inflow conduit 640, is filtered by the gravel aggregate bed 628, in order to be discharged through outlet 650 in a cleaned condition. In correspondence with the first and the fifth embodiments, the housing is double-walled, i.e., provided with a hollow space 680 which is defined by an inner wall 681 and an outer wall 682. In order to sterilize the interior of the filter, hot water or hot vapor is supplied to the inlet 685 and discharged through the outlet 686. By sealing in a pressure-tight manner by means of closing the valves 641 and 651 the filter housing 610 can be sealed in a pressure-tight manner, and the fluid contained therein can be heated to a high temperature.

All embodiments have in common that the strain-free assembly and the pressure-tight realization allow temperature gradients of up to 10° C./min and sterilizing temperatures of 121° C. to 140° C. In a particularly uniform embodiment even higher temperature gradients can be obtained.

Basically, the “enclosed cooking pot embodiment” allows the realization of a uniform heating process, which does not negatively affect the membranes, and in particular their pottings, by disadvantageous harmful flow loads, by additional pressure losses or vibrations, or by other pressure blows. Only the different material expansion of the components occurs. However, this material expansion is not associated with any effect caused by a damage, if the construction is correspondingly stress-free.

The sterilizing temperature is, thus, significantly increased, and the lifetime of the membrane is clearly prolonged. With the aforementioned externally heatable modules a sterilization is possible both manually and automatically.

The advantages of the disclosure are that the membrane element can be sterilized with hot water by a corresponding material selection (membrane, membrane housing, potting). Hot water implies a temperature range of up to 150° C. The vapor pressure is, in this case, above the pressure of the boiling curve. At 140° C. the pressure has to be greater than, for example, 3.6 bar. The principle is comparable with that of a pressure cooker. Thus, all common sterilization profiles corresponding to the elimination kinetics for each germ according to D- and Z-values may be used. By means of the temperatures each dead spot and pool inside the membrane module is accessible. A thorough heating is obtained. A fluidic material exchange at these spots is still not achieved, however. In this connection one talks about “oversterilization”. Any optional heating medium or cooling medium may be used in the heating jacket and cooling jacket. This jacket space is safely separated from the system. As a rule, temperature gradients of 1° C./minute are used for heating and cooling. It may also be the case, however, that gradients up to about 10° C./minute can be obtained with this method. The mounting of the module with a spring allows the compensation of the heat expansion during the sanitation/sterilization. The double jacket heating method and its constructive characteristic are usable for all membrane element filters from microfiltration (MF) via ultrafiltration (UF) to the reverse osmosis (RO).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A filter module comprising:
a filter housing for receiving a fluid to be filtered, the filter housing being sealable in a pressure-tight manner; and
a heating device for heating the fluid in the filter housing.

2. The filter module according to claim 1 further comprising at least one closable inlet for supplying the fluid to be filtered to the filter housing, and at least one closable outlet for discharging the fluid from the filter housing after being filtered.

3. The filter module according to claim 1 wherein the heating device comprises a jacket for the filter housing, the jacket being, at least in part, double-walled, with a hollow space between the walls, and wherein the hollow space is configured to be filled with and/or flown through by a heating medium.

4. The filter module according to claim 3 wherein the heating device further comprises an intake and a drain for the heating medium.

5. The filter module according to claim 3 wherein the heating device comprises at least one electric heating element arranged, at least in part, in the hollow space.

6. The filter module according to claim 1 wherein the heating device comprises at least one electric heating element arranged in or on the filter housing.

7. The filter module according to claim 6 wherein the at least one electric heating element comprises a heating cable and/or a Peltier element.

8. The filter module according to claim 1 wherein the heating device comprises at least one electric heating element arranged on an inner side of the filter housing that faces the fluid when the fluid is received in the filter housing.

9. The filter module according to claim 1 wherein the heating device comprises at least one electric heating element integrated in a wall of the filter housing.

10. The filter module according to claim 1 wherein the heating device comprises a firing system for heating the filter housing.

11. The filter module according to claim 1 further comprising one or more membranes arranged in the filter housing for filtering the fluid.

12. The filter module according to claim 1 further comprising a gravel aggregate bed arranged in the filter housing for filtering the fluid.

13. A method for sterilizing a filter module, the method comprising:
sealing a filter housing in a pressure-tight manner;
heating fluid in the filter housing to a sterilizing temperature; and
maintaining the sterilizing temperature of the fluid in a predetermined temperature range for a predetermined period.

14. The method according to claim 13 wherein the predetermined temperature range is in the range of 100° C. to 150° C., and wherein the predetermined period is in the range of 1 minute to 60 minutes.

15. The method according to claim 13 wherein the predetermined temperature range is in the range of 121° C. to 140° C., and wherein the predetermined period is in the range of 5 minutes to 20 minutes.

16. The method according to claim 13 wherein the heating of the fluid is accomplished by hot water and/or hot vapor flowing through a jacket on the filter housing.

17. The method according to claim 16 further comprising, after the heating of the fluid to the sterilizing temperature and after maintaining the sterilizing temperature of the fluid, cooling the fluid by flowing water through the jacket that has a lower temperature than the hot water and/or the hot vapor.
